(19) United States
(12) Patent Application Publication
(10) Pub. No.: US 2008/0230132 A1
(43) Pub. Date: Sep. 25, 2008

(54) Fluid and gas distribution manifolds to which connectors and valves bodies are joined with brazed, silver-soldered or chemically-bonded connections

(76) Inventor: LeRoy Frank Cowan, Highland, UT (US)

Correspondence Address: Angus C. Fox, III, 4093 N. Imperial Way, Provo, UT, 84604-5386, US

(21) Appl. No.: 11/726,146

(22) Filed: Mar. 21, 2007

(51) Int. Cl. F16K 1/32

(52) U.S. Cl. 137/872; 137/15.18

(57) ABSTRACT

The present invention provides several embodiments of manifolds and distribution assemblies, having a manifold main body or multiple interconnecting tubular members and multiple connectors and/or valves which are unitary with the main body or tubular members. Some of the manifolds have four connectors in a common plane at right-angle intervals. For metal manifold assemblies, required pipe fittings and ball valves are welded, brazed or silver-soldered directly to the main body of the manifold. For polymeric plastic assemblies, chemical bonding of components is utilized. A distribution assembly made of metal or polymeric plastic, and having valves and connectors that are unitary is also disclosed. Intersecting tubular members can be cast or injection molded.

This application has a priority date based on the filing of provisional patent application 60/784,002, which was filed on Mar. 19, 2006, and is also related to application Ser. No. 10/340,912, which was filed by the same inventor on Jan. 10, 2003, and which issued as U.S. Pat. No. 6,971,399.

### FIELD OF THE INVENTION

This invention relates, generally, to connectors, collectors and valves for pipe systems, and more particularly to manifolds used for the collection or distribution of water, compressed air, and other fluids and compressed gases.

### BACKGROUND OF THE INVENTION

Potable water, electric power and natural gas are typically provided to individual subscribers by public utility companies. The term “public utility” denotes that the public receives either the water, power or gas from the companies, but does not imply that those companies are necessarily publicly owned, as they may be either publicly or privately owned. In the event of an emergency, such as an earthquake or other catastrophic event, public utility delivery systems for potable water, natural gas, and electric power are likely to be disrupted. If such an emergency event were to occur, a lack of potable water would likely be of most immediate concern.

In U.S. Pat. No. 6,971,399 (hereinafter, also referred to as the '399 patent), the same inventor discloses an integrated emergency back-up system for a building, such as a residence, that is normally supplied with culinary water, electric power and natural gas by public utilities. This patent is incorporated, by reference, in its entirety. The back-up system includes at least one water storage reservoir having an upper input coupled to a public water utility main line; an electric generator powered by an internal combustion engine; and an electric air compressor having a compressed air storage tank which provides elevated air pressure to the water storage reservoir(s) in the event that water pressure from the public water utility main line fails. The electric air compressor is operable from power supplied by either a public electric utility or said electric generator. The emergency utility backup system may also include a tank for storing a liquid hydrocarbon fuel that may be utilized for both the electric generator and a heating system for the building. Electric power to the building is supplied either from an electric utility source through circuit breakers located within a main circuit breaker panel, of from the electric generator through breakers in a load distribution and transfer switch box. For a preferred embodiment of the back-up system, the water storage reservoir(s) is/are coupled to the water main through an anti-siphon valve. The anti-siphon valve cuts off the connection to the water main when the pressure in the water main drops below a set value, thereby preventing water from the water storage reservoir(s) from being depleted through siphoning. There is also a readily-accessible shut-off valve (in addition to the water utility shut-off valve next to the water meter), with which the supply water from the municipal water supply may be cut if, for example, it is contaminated. With the municipal water supply cut off, water for the building is drawn from the water storage reservoirs. Until the municipal water supply is considered safe, or restored, the water in the water storage reservoirs can be replenished from safe sources. Each water storage reservoir is equipped with a first hose bib or valve and connector, at the top thereof, through which the reservoir may be filled from a truck-mounted tank or other replenishing system, and a second hose bib or valve and connector at the bottom thereof, through which the reservoir may be drained. If multiple water storage reservoirs are used, they are coupled in series so that water flows from the first to the second, the second to the third, and so on, thereby ensuring that each reservoir is continually replenished with a supply of non-stagnant water from the water main during periods of normal daily operation. Compressed air from the holding tank is fed to the first water storage reservoir so as to provide water pressure for the stored emergency water. Alternatively, pressurization of stored potable water may be accomplished with a liquified pressurized gas, such as carbon dioxide, or any other source of pressurization. As a consequence of the multiple connections made to and between the various water storage reservoirs, the required plumbing can be time consuming to construct.

Although the focus of the present invention is the simplification of the plumbing connections of the emergency back-up system disclosed in the above-referenced patent, the components disclosed herein may be useful for other applications.

### SUMMARY OF THE INVENTION

The present invention provides several embodiments of manifolds having a manifold main body and multiple connectors and/or valves which are unitary with the main body. Several of the connectors and/or valves may lie in a common plane at right-angle intervals. The manifold body may be fabricated from copper, brass, stainless steel, or a suitable structural polymeric plastic compound, such as polyvinyl chloride. For a manifold main body fabricated from copper, required pipe fittings and ball valves are generally made of brass, and are brazed directly to the main body without the use of female sockets and close nipples for interconnections. For a manifold main body made of brass, brass pipe fittings and ball valves are soldered to the main body. For a manifold main body made of stainless steel, brass pipe fittings and ball valves are preferably brazed to the main body. For a manifold main body made of a polymeric plastic compound, the pipe fittings and ball valves are also made of polymeric plastic compound and are chemically bonded to the main body. This particular manifold design decreases the cost of components required to construct a functionally equivalent structure using one or more brass cross pipe fittings, multiple pipe brass nipples, and multiple ball valves. Although the cost of such build-up components may be reduced by using galvanized pipe and pipe fittings, long-term corrosion problems associated with galvanized components makes such a choice unwise when the goals of long-term leak prevention and cost minimization are considered. In addition, by building the desired manifolds for which the main body and the fitting and valves are unitary, the number of parts is reduced greatly compared with comparable structures made from discrete pipe fitting components. Fewer discrete parts also means that there are fewer joints where leaks can occur.

Also disclosed herein are a pair of embodiments of a distribution assembly that incorporates four full-port valves and four connectors designed to couple to cross-linked polyethylene (PEX) tubing. The distribution assembly includes interconnecting tubular members that are unitary with the valve bodies. Like the manifolds, the distribution assemblies can be made of metal of polymeric plastic. T-shaped elements can be fabricated from individual metal tubular pieces that are welded, brazed or soldered together, from individual polymeric plastic tubular pieces that are chemically bonded together, from a single brass casting, or from a single injection molded piece of polymeric plastic.

### BRIEF DESCRIPTION OF THE DRAWINGS

FIG. 1 is a side elevational view of a first embodiment manifold to which four ball valves and a male pipe connector fitting have been attached;

FIG. 2 is a side elevational view of a second embodiment manifold to which three ball valves and a male pipe connector fitting have been attached;

FIG. 3 is a side elevational view of a third embodiment manifold to which two ball valves and a male pipe connector fitting have been attached;

FIG. 4 is a side elevational view of a fourth embodiment manifold which incorporates four full-port ball valves; and

FIG. 5 is a side elevational view of an alternate fourth embodiment manifold.

### PREFERRED EMBODIMENT OF THE INVENTION

The various embodiments of the invention will now be described in detail with reference to the attached drawing figures. It is to be understood that the drawings are not necessarily drawn to scale and that they are intended to be merely illustrative.

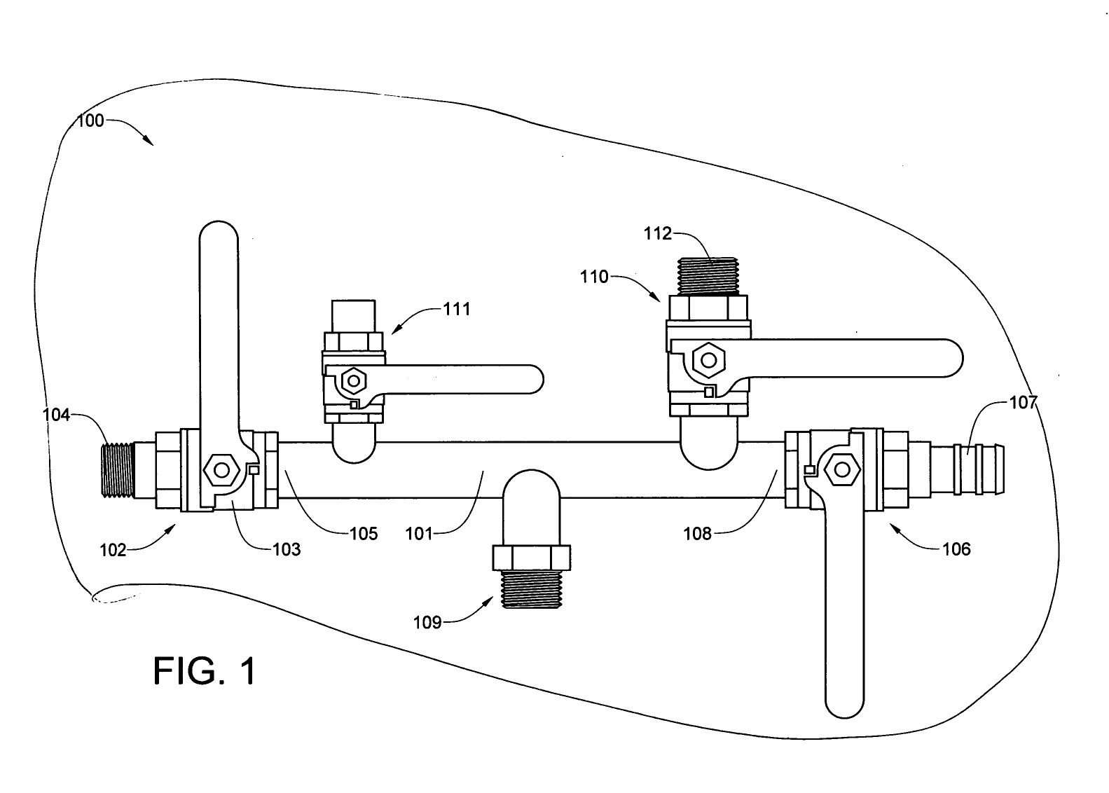

Referring now to FIG. 1, the first embodiment manifold 100 is intended for use on top of the first water storage tank 102A of the integrated emergency back-up system of U.S. Pat. No. 6,971,399 (hereinafter the '399 patent). The manifold has a tubular main body 101. A hose bib 102, incorporating a full-port ball valve 103 and an external male connector 104, is brazed to a first end 105 of the tubular main body 101. A ball valve 106 incorporating an external female connector 107 is brazed to a second end 108 of the tubular main body 101. The external female connector 107 will be coupled to the storage tank of an air compressor. A male connector 109, which is attached to the bottom of the tubular main body 101, will be coupled to the upper port of the first water storage tank 102A. A full-port ball valve 110 is attached to the top of the tubular main body 101, as is a smaller another ball valve 111 that will be used as a bleeder valve. Full-port ball valve 110 will be coupled to the municipal water main.

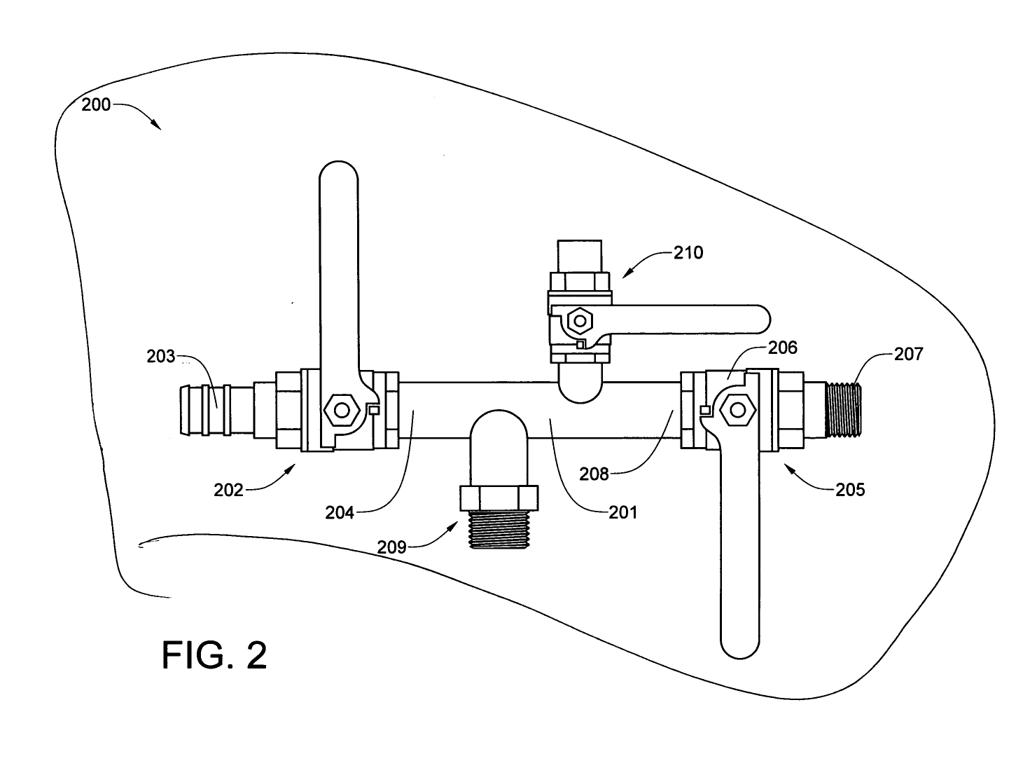

Referring now to FIG. 2, the second embodiment manifold 200, which is intended for use on top of the second water storage tank 102B of the integrated emergency back-up system of the '399 patent, also has a tubular main body 201. A first full-port ball valve 202 having an external male connector 203 is attached to a first end 204 of the main body 201. A second full-port ball valve 205 also having an external male connector 206 is attached to a second end 207 of the main body 201. The first full-port ball valve 202 will be coupled to the bottom port of water storage tank 102A, while the second full-port ball valve 205 will serve as a hose bib. In addition, a male connector 208 attached to the bottom of the tubular main body 101 will be coupled to the upper port of the second water storage tank 102B shown in the '399 patent. Another ball valve 209, which is attached to the top of the tubular main body 201, will function as a bleeder valve.

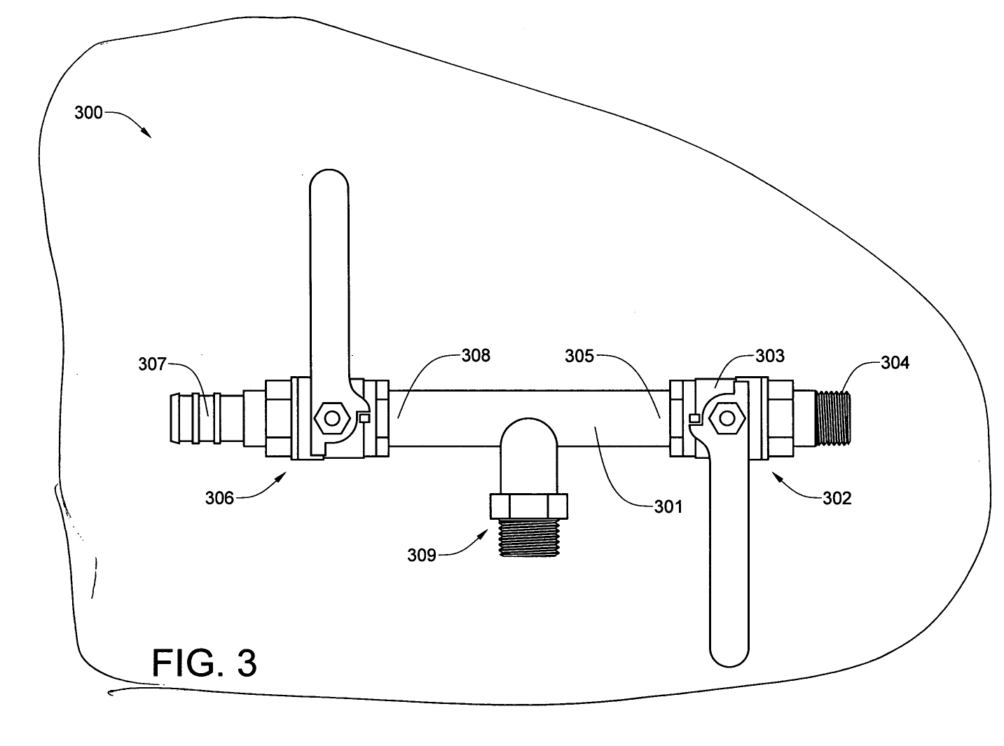

Referring now to FIG. 3, a third embodiment manifold 300 is intended for use at the bottom of both first water storage tank 102A and second water storage tank 102B of the '399 patent. The third embodiment manifold 300 also includes a tubular main body 301. First and second full-port ball valves 302 and 303, respectively, each having a male connector are attached at opposite ends of the tubular main body 301. A male connector, which is attached to the top of the tubular main body 301, will connect to the lower port of either first water storage tank 102A or second water storage tank 102B.

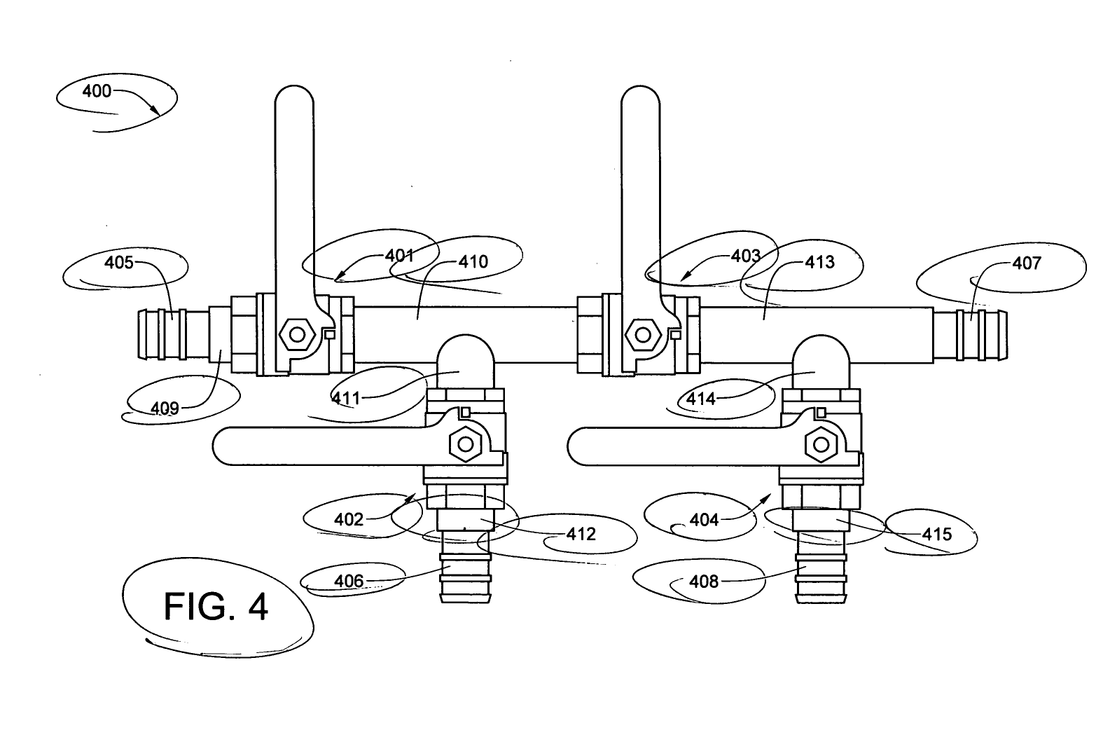

Referring now to FIG. 4, a distribution assembly 400 is intended to replace valves 111, 112, 114, and 119 of FIG. 1 of the '399 patent, as well as the interconnecting pipes, and incorporates four full-port ball valves 401, 402, 403 and 404. There are four connectors 405, 406, 407, and 408, all of which are barbed connectors for connection to cross-lined polyethylene (PEX) tubing. The valve bodies of valves 401, 402, 403 and 404, the four barbed connectors 405, 406, 407, and 408, and interconnecting tubular members 409, 410, 411, 412, 413, 414 and 415 are all unitary.

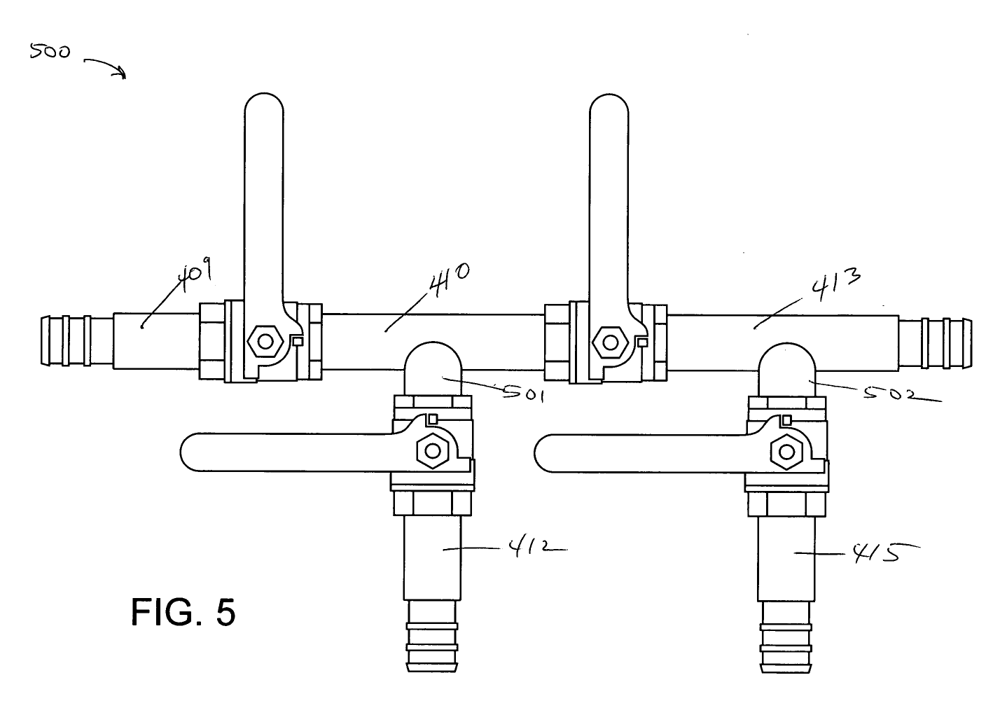

Referring now to FIG. 5, an alternative distribution assembly 500 is functionally identical to the distribution assembly of FIG. 4. The difference is that the interconnecting elements 411 and 414 have been shortened to improve the rigidity and structural integrity of the assembly.

The manifold main bodies of the first, second and third embodiment manifolds 100, 200 and 300, respectively, may be fabricated from copper, brass, stainless steel, or a suitable structural polymeric plastic compound, such as polyvinyl chloride. For a manifold main body fabricated from copper, required pipe fittings and ball valves are generally made of brass, and are brazed directly to the main body without the use of female sockets and close nipples for interconnections. For a manifold main body made of brass, brass pipe fittings and ball valves are soldered to the main body. For a manifold main body made of stainless steel, brass pipe fittings and ball valves are preferably brazed to the main body. For a manifold main body made of a polymeric plastic compound, the pipe fittings and ball valves are also made of polymeric plastic compound and are chemically bonded to the main body. This particular manifold design decreases the cost of components required to construct a functionally equivalent structure using one or more brass cross pipe fittings, multiple pipe brass nipples, and multiple ball valves. As with the manifold embodiments 100, 200 and 300 described above, the distribution assemblies of FIGS. 4 and 5 can be fabricated from copper, brass, stainless steel or a suitable polymeric plastic compound. If fabricated primarily from copper, the valves and connectors are brazed directly to the copper portions. The “T” connections formed by the intersection of tubular members 410 and 411, and by the intersection of tubular members 413 and 414 can be fabricated from straight copper tubular sections that are brazed or silver-soldered together, from straight brass sections that are sliver-soldered together, from a single brass casting, from a single piece of machined brass, from stainless steel tubes that are welded together, from polyvinylchloride pieces that are chemically bonded together, or from a single molded polymeric plastic piece.

Although only several embodiments of the new copper manifold having fittings brazed thereto, have been heretofore described, it will be obvious to those having ordinary skill in the art that changes and modifications may be made thereto without departing from the scope and the spirit of the invention as hereinafter claimed.

1. (canceled)

2. A manifold assembly comprising:
at least one tubular main body;
at least three valve bodies, two of which are mounted at opposite ends of said tubular main body, and at least one other of which is mounted on a cylindrical surface of said tubular main body; and
wherein said valve bodies and said tubular main body are unitary.

3. The manifold assembly of claim 1, wherein said valve bodies and said tubular main body are joined using a method selected from the group consisting of welding, brazing, silver soldering, and chemical bonding.

4. The manifold assembly of claim 1, wherein said valve bodies and said tubular main body are injection molded as a single unit.
